(19) United States
(12) Patent Application Publication
(10) Pub. No.: US 2025/0102998 A1
(43) Pub. Date: Mar. 27, 2025

(54) IMAGE FORMING APPARATUS AND ATTACHABLE BODY

(71) Applicant: FUJIFILM Business Innovation Corp., Tokyo (JP)

(72) Inventors: Kaito ITOKAWA, Kanagawa (JP); Yuta HOSHINO, Kanagawa (JP)

(73) Assignee: FUJIFILM Business Innovation Corp., Tokyo (JP)

(21) Appl. No.: 18/588,941

(22) Filed: Feb. 27, 2024

(30) Foreign Application Priority Data
Sep. 27, 2023 (JP) 2023-165875

(51) Int. Cl. G03G 21/16

(52) U.S. Cl. CPC G03G 21/1661

(57) ABSTRACT

An image forming apparatus includes an apparatus body, and multiple receiving portions that receive multiple attachable bodies to each of which a removable member is attachable. A first one of the multiple attachable bodies attached to the apparatus body is allowed to be attached to a corresponding one of the receiving portions while the removable member is attached to the first attachable body, and a second one of the multiple attachable bodies is prevented from being attached to a corresponding one of the receiving portions while the removable member is attached to the second attachable body.

### CROSS-REFERENCE TO RELATED APPLICATIONS

This application is based on and claims priority under 35 USC 119 from Japanese Patent Application No. 2023-165875 filed Sep. 27, 2023.

### BACKGROUND

### (i) Technical Field

The present disclosure relates to an image forming apparatus and an attachable body.

### (ii) Related Art

Japanese Unexamined Patent Application Publication No. 2010-197503 discloses a process of determining, as a failure to remove a protective member, a detection of attachment of a process cartridge to an image forming apparatus and a torque measured by a torque sensor when a driving source rotates a photoconductor drum being smaller than or equal to a threshold.

Japanese Unexamined Patent Application Publication No. 2006-308799 discloses a structure where a waste toner container that collects waste toner recovered from a photoconductor drum is removably installed in a space between a transfer roller guide and an inner access cover.

Japanese Unexamined Patent Application Publication No. 2000-181328 discloses a structure having an opening with a shape that prevents attachment of a process cartridge while a cover member of the process cartridge is attached to a frame.

### SUMMARY

A removable member that is attachable and removable may be attached to an attachable body to be attached to an image forming apparatus. During an operation of an image forming apparatus, the operation of the image forming apparatus may be performed while an attachable body from which the removable member is removed is attached to the image forming apparatus.

When the attachable body is to be attached to an image forming apparatus by an operator inexperienced in the operation, the removable member may fail to be removed, and the operation of the image forming apparatus may be performed while the attachable body is attached to the image forming apparatus and the removable member remains attached to the attachable body. In this case, the image forming apparatus or the attachable body may cause a trouble.

On the other hand, when an attachable body is allowed to be attached to an image forming apparatus while a removable member is attached to the attachable body, for example, the image forming apparatus is allowed for shipment while an attachable body to which a removable member is attached is attached to the image forming apparatus. In this case, a trouble such as a shipment of an attachable body separate from the image forming apparatus is avoidable.

Aspects of non-limiting embodiments of the present disclosure relate to an image forming apparatus that allows a subset of multiple attachable bodies attachable to the image forming apparatus to be attached thereto while a removable member is attached to the subset of attachable bodies, and that prevent another subset of the multiple attachable bodies from being attached thereto while a removable member is attached to the subset of attachable bodies.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including an apparatus body and multiple receiving portions that receive multiple attachable bodies to each of which a removable member is attachable, wherein a first one of the multiple attachable bodies attached to the apparatus body is allowed to be attached to a corresponding one of the receiving portions while the removable member is attached to the first attachable body, and a second one of the multiple attachable bodies is prevented from being attached to a corresponding one of the receiving portions while the removable member is attached to the second attachable body.

### BRIEF DESCRIPTION OF THE DRAWINGS

Exemplary embodiments of the present disclosure will be described in detail based on the following figures, wherein:

FIG. 1 is a diagram of an image forming apparatus;

FIG. 2 is a perspective view of a spot-color attachable body;

FIG. 3 is a diagram of a spot-color removable member viewed in a direction of arrow III in FIG. 2;

FIG. 4 is a perspective view of a process-color attachable body;

FIG. 5 is a diagram of a process-color attachable body starting to be attached to an apparatus body of an image forming apparatus;

FIG. 6 is a diagram of a spot-color attachable body starting to be attached to an apparatus body of an image forming apparatus; and

FIGS. 7A and 7B are diagrams of a receiving portion with another structure.

### DETAILED DESCRIPTION

One or more exemplary embodiments of the present disclosure are described below with reference to the attached drawings.

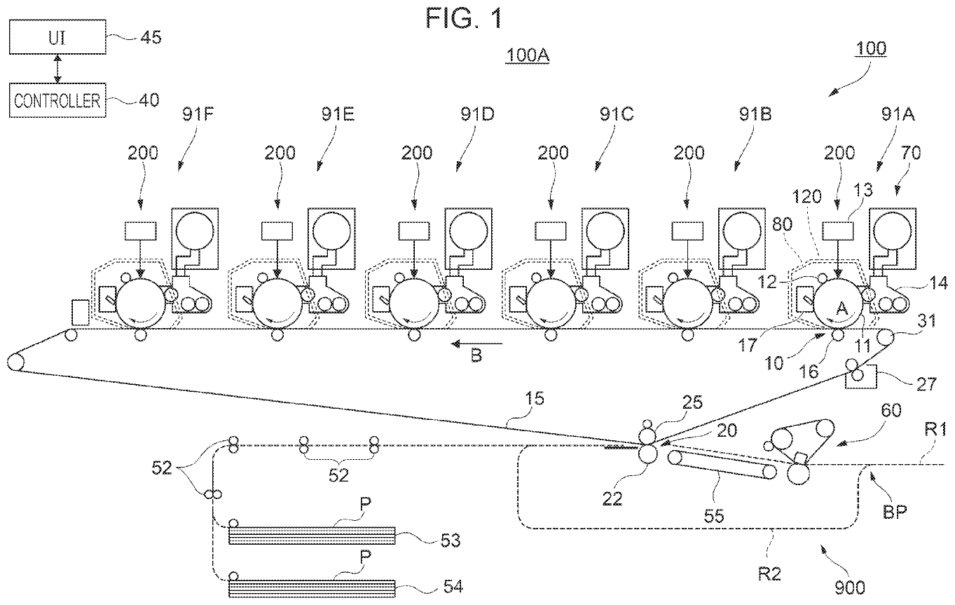

FIG. 1 is a diagram of an image forming apparatus 100 according to an exemplary embodiment. FIG. 1 illustrates the image forming apparatus 100 viewed from the front of the image forming apparatus 100.

The image forming apparatus 100 is an intermediate-transfer image forming apparatus called a tandem image forming apparatus.

The image forming apparatus 100 includes multiple image forming portions 200 that form images to be transferred to sheets P serving as an example of recording media.

Each of the image forming portions 200 includes a photoconductor drum 11 as an example of an image carrier.

Each of the image forming portions 200 forms toner images, or images to be transferred to a sheet P, on the photoconductor drum 11 with a developer containing toner. In other words, each of the image forming portions 200 forms toner images on the photoconductor drum 11 with a powdery developer.

The developer according to the present exemplary embodiment includes a dry carrier and a dry toner. Each of the image forming portions 200 forms toner images on the photoconductor drum 11 with the carrier and the toner.

Six image forming portions 200 form toner images on the corresponding photoconductor drums 11 with developers of different colors.

More specifically, in the present exemplary embodiment, four of the six image forming portions 200 denoted with reference signs 91A to 91D respectively form toner images with developers of four colors of yellow, magenta, cyan, and black. In other words, these four image forming portions 200 form toner images with process-color developers of yellow, magenta, cyan, and black.

More specifically, one of the four image forming portions 200 denoted with reference sign 91A forms yellow toner images with a yellow developer, and one of the four image forming portions 200 denoted with reference sign 91B forms magenta toner images with a magenta developer.

One of the four image forming portions 200 denoted with reference sign 91C forms cyan toner images with a cyan developer, and one of the four image forming portions 200 denoted with reference sign 91D forms black toner images with a black developer.

The remaining two image forming portions 200 denoted with reference signs 91E and 91F form toner images with spot-color developers for colors other than the above four colors, such as clear, white, gold, silver, pink, green, or orange.

Examples of spot-color developers include a developer including a magnetic toner and a developer including an electroconductive toner. The spot-color developers also include, for example, a developer including toner that emits light when irradiated with light such as ultraviolet rays or infrared rays.

In the present exemplary embodiment, a binary developer including a mixture of a carrier and toner is used as an example of the developer, but the developer is not limited to this. A single-component developer simply including toner may be used as the developer.

Each of the image forming portions 200 includes a development device 14.

Each of the image forming portions 200 further includes a dispensing device 70 that provides a developer to the corresponding development device 14.

The development device 14 causes toner serving as the developer to adhere to the photoconductor drum 11 to form an electrostatic latent image on the photoconductor drum 11 into a visible image with the toner. In other words, the development device 14 performs development on the photoconductor drum 11 serving as an image carrier to form a toner image with the toner on the photoconductor drum 11.

The dispensing device 70 provides the developer to the development device 14.

As described above, the developer includes a carrier and toner, and the dispensing device 70 replenishes the development device 14 with the carrier and the toner as the developer. In the present exemplary embodiment, the carrier has a positive polarity, and the toner has a negative polarity.

Each of the image forming portions 200 includes an attachable body 80.

In the present exemplary embodiment, each attachable body 80 is attached to an apparatus body 100A of the image forming apparatus 100 at a portion where the corresponding image forming portion 200 is disposed.

In the present exemplary embodiment, the apparatus body 100A of the image forming apparatus 100 has multiple recessed receiving portions 120. In the present exemplary embodiment, each of the image forming portions 200 includes the receiving portion 120.

In the present exemplary embodiment, each attachable body 80 is received in the corresponding one of the receiving portions 120 and attached thereto.

In the present exemplary embodiment, each attachable body 80 is attachable to and removable from the corresponding receiving portion 120 to enable replacement with another attachable body 80 as appropriate.

Each of the attachable bodies 80 includes multiple components. In the present exemplary embodiment, each attachable body 80 includes the photoconductor drum 11, the charging member 12, and a drum cleaner 17 as examples of components.

As described above, the photoconductor drum 11 serving as an example of an image carrier carries a toner image to be formed. The photoconductor drum 11 rotates in a direction of arrow A.

The charging member 12 is disposed in close contact with the photoconductor drum 11 to charge the photoconductor drum 11 with electricity. In the present exemplary embodiment, a voltage is applied across the charging member 12 and the photoconductor drum 11 to charge the photoconductor drum 11 with electricity.

The drum cleaner 17 removes the developer remaining on the photoconductor drum 11.

In the present exemplary embodiment, each of the image forming portions 200 further includes an exposure device 13.

The exposure device 13 forms electrostatic latent images on the photoconductor drum 11 by irradiating the photoconductor drum 11 with light. The exposure device 13 includes a light source such as a light emitting diode (LED), and irradiates the photoconductor drum 11 with light emitted from the light source.

The image forming apparatus 100 further includes an intermediate transfer belt 15 to which the toner images formed by each of the image forming portions 200 are transferred, and first transfer portions 10 that transfer the toner images formed by the image forming portions 200 to the intermediate transfer belt 15.

Each first transfer portion 10 includes a first transfer roller 16 that transfers toner images formed on the corresponding photoconductor drum 11 to the intermediate transfer belt 15. Each first transfer portion 10 includes the first transfer roller 16 disposed across the intermediate transfer belt 15 from the photoconductor drum 11.

The image forming apparatus 100 further includes a second transfer portion 20 that transfers toner images transferred to the intermediate transfer belt 15 to a sheet P.

The intermediate transfer belt 15 is circularly moved by a driving roller 31 driven by a motor not illustrated at a predetermined rate in a direction of arrow B in FIG. 1.

In the present exemplary embodiment, the toner images on the respective photoconductor drums 11 are sequentially electrostatically attracted to the intermediate transfer belt 15, and thus the superposed toner images are formed on the intermediate transfer belt 15.

The second transfer portion 20 includes a second transfer roller 22 disposed on the outer side of the intermediate transfer belt 15, and a backup roller 25 disposed on the inner side of the intermediate transfer belt 15.

In the present exemplary embodiment, the toner images formed by the image forming portions 200 and transferred to the intermediate transfer belt 15 are transferred at the second transfer portion 20 to the sheet P that has been transported to the second transfer portion 20.

The image forming apparatus 100 further includes a fixing device 60 that fixes the toner images transferred to the sheet P onto the sheet P.

The image forming apparatus 100 further includes a controller 40 that includes a CPU for executing programs, and that controls components in the image forming apparatus 100.

The image forming apparatus 100 further includes a user interface (UI) 45 that includes components such as a display panel. The user interface 45 receives instructions from users, and displays information for the users.

The image forming apparatus 100 further includes a reverse mechanism 900 that turns the sheet P upside down.

The reverse mechanism 900 turns the sheet P that has received toner images transferred by the second transfer portion 20 on one surface upside down, and then feeds the sheet P again to the second transfer portion 20. Thus, the present exemplary embodiment forms toner images on both surfaces of the sheet P.

More specifically, in the present exemplary embodiment, the reverse mechanism 900 turns the sheet P upside down by transporting the sheet P that has passed through the fixing device 60 to a branch path R2 that diverges from a sheet transport path R1. More specifically, the reverse mechanism 900 transports, in a reversed direction, the sheet P that has passed a divergence point BP, and then feeds the sheet P to the branch path R2.

The branch path R2 merges with the sheet transport path R1 at a portion upstream from the second transfer portion 20. Thus, in the present exemplary embodiment, the sheet P that is turned upside down is fed to the second transfer portion 20 again. In this case, the toner images are formed on one surface of the sheet P as well as on the other surface of the sheet P, that is, on both surfaces of the sheet P.

The process flow performed by the image forming apparatus 100 is described.

The image forming apparatus 100 receives image data output from, for example, a computer or an image reading device not illustrated. Then, the image forming apparatus 100 performs image processing on the image data. Thus, the image forming apparatus 100 generates pieces of image data corresponding to the multiple image forming portions 200.

The generated image data is output to the exposure device 13 of each of the image forming portions 200.

The exposure device 13 irradiates the photoconductor drum 11 with light in accordance with the input image data.

In the present exemplary embodiment, after the charging member 12 charges the surface of the photoconductor drum 11 with electricity, the exposure device 13 exposes the surface to light to scan the surface. Thus, an electrostatic latent image is formed on the surface of the photoconductor drum 11.

The development device 14 then performs a development process to form a toner image on the photoconductor drum 11. This toner image is transferred to the intermediate transfer belt 15 at the first transfer portion 10.

After the toner images are transferred to the intermediate transfer belt 15, the toner images are moved to the second transfer portion 20 with movement of the intermediate transfer belt 15. At this time, the sheet P from a first sheet container 53 or a second sheet container 54 is transported to the second transfer portion 20 by, for example, transport rollers 52.

The toner images on the intermediate transfer belt 15 are collectively electrostatically transferred to the sheet P at the second transfer portion 20.

The sheet P to which the toner images are transferred is then detached from the intermediate transfer belt 15, and transported to a transport belt 55. The transport belt 55 transports the sheet P to the fixing device 60.

The sheet P transported to the fixing device 60 is heated and pressed by the fixing device 60. The toner images on the sheet P are thus fixed to the sheet P. The sheet P is then discharged from the image forming apparatus 100.

To form the toner images on both surfaces of the sheet P, after the sheet P has passed through the fixing device 60, the sheet P is fed to the second transfer portion 20 again through the branch path R2.

The toner images are then transferred to another surface of the sheet P at the second transfer portion 20. The sheet P then passes through the fixing device 60 again, and the toner images transferred to the surface are fixed to the sheet P.

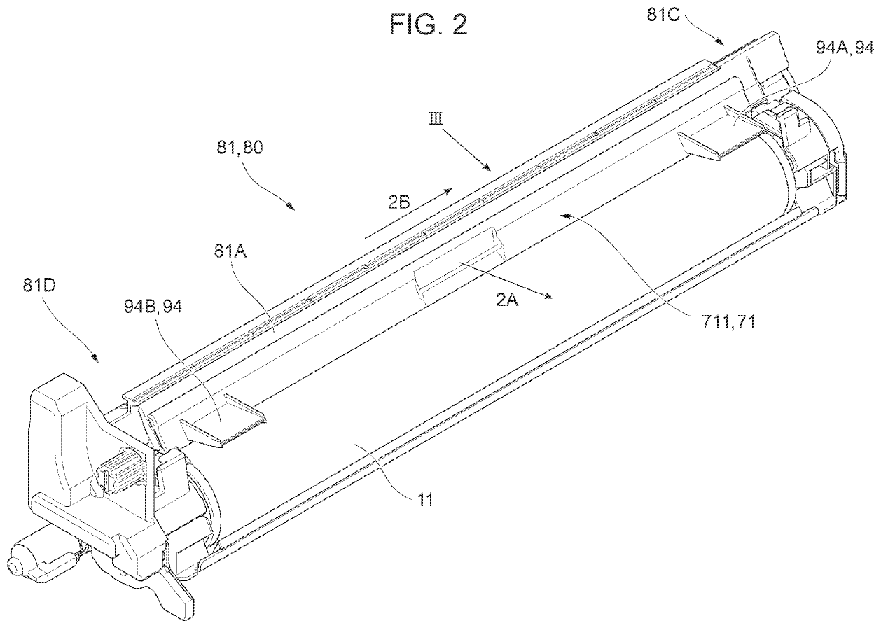

FIG. 2 is a perspective view of an attachable body 80 for each spot color.

FIG. 2 illustrates the attachable body 80 for each spot color to be attached to the corresponding one of the image forming portions 200 denoted with reference signs 91E and 91F in FIG. 1.

As described above, the attachable body 80 for each spot color (referred to as “a spot-color attachable body 81”, below) includes the photoconductor drum 11 serving as an example of an image carrier.

The spot-color attachable body 81 further includes a fixing member 81A to which the photoconductor drum 11 is fixed.

A charging member 12 (not illustrated in FIG. 2) illustrated in FIG. 1 is installed on the back of the fixing member 81A. The spot-color attachable body 81 further includes a drum cleaner 17 (not illustrated in FIG. 2) illustrated in FIG. 1.

The spot-color attachable body 81 further includes a removable member 71 attached to the spot-color attachable body 81. Herein, the removable member 71 attached to the spot-color attachable body 81 is referred to as a spot-color removable member 711 below.

The spot-color removable member 711 is attachable to and removable from the spot-color attachable body 81. In other words, the present exemplary embodiment allows removal of the spot-color removable member 711 from the spot-color attachable body 81.

The spot-color attachable body 81 according to the present exemplary embodiment is an attachable body to which the spot-color removable member 711 is attachable.

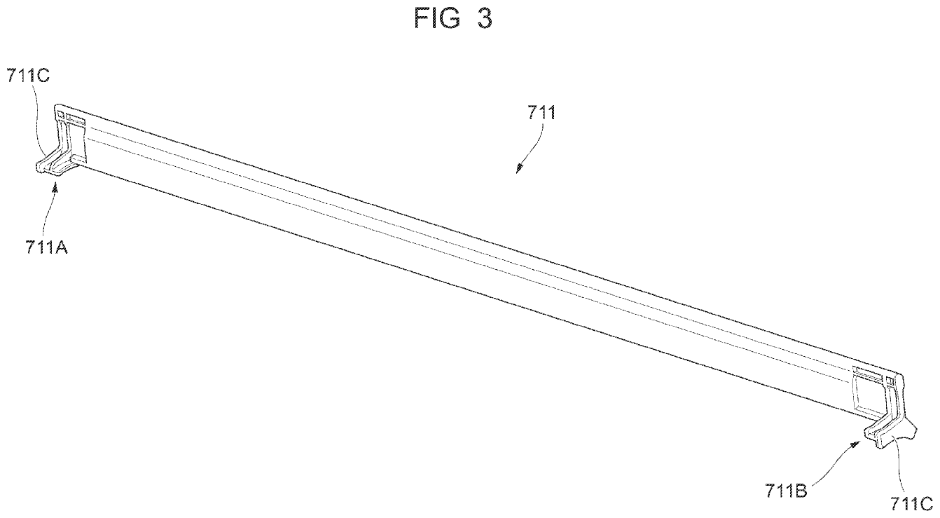

FIG. 3 is a diagram of the spot-color removable member 711 viewed in a direction indicated with arrow III in FIG. 2.

The spot-color removable member 711 includes spacing protrusions 711C that protrude in a direction crossing the longitudinal direction of the spot-color removable member 711 at a first end portion 711A and a second end portion 711B in the longitudinal direction.

In the present exemplary embodiment, as illustrated in FIG. 2, in the state where the spot-color removable member 711 is attached to the spot-color attachable body 81, the spacing protrusions 711C are placed between the photoconductor drum 11 and the charging member 12 (refer to FIG. 1).

Thus, the charging member 12 moves away from the photoconductor drum 11 to be spaced apart from the photoconductor drum 11.

The spot-color removable member 711 is a member that separates a subset of multiple components forming the spot-color attachable body 81 from another subset of the multiple components.

More specifically, the spot-color removable member 711 is a member that separates the charging member 12, serving as an example of a component included in the spot-color attachable body 81, from the photoconductor drum 11, serving as an example of another component included in the spot-color attachable body 81.

A process-color removable member 712, described below, is also a member that separates the charging member 12 from the photoconductor drum 11 disposed at a process-color attachable body 82 (described below).

In the present exemplary embodiment, the charging member 12 (not illustrated in FIG. 2) is urged by an urging member, not illustrated, disposed at the spot-color attachable body 81 (refer to FIG. 2) toward the photoconductor drum 11.

When the spot-color removable member 711 is attached to the spot-color attachable body 81, the charging member 12 moves against an urging force exerted on the charging member 12 from the urging member. Thus, the charging member 12 moves away from the photoconductor drum 11 to be spaced apart from the photoconductor drum 11.

When the spot-color removable member 711 is removed from the spot-color attachable body 81, the charging member 12 moves toward the photoconductor drum 11 to come into contact with the photoconductor drum 11.

As in the present exemplary embodiment, a structure in which the spot-color removable member 711 is included and the charging member 12 is spaced apart from the photoconductor drum 11 is less likely to cause troubles attributable to deformation of the charging member 12.

When the charging member 12 keeps in contact with the photoconductor drum 11, the charging member 12 is more likely to be deformed. When deformed, the charging member 12 may cause a trouble such as nonuniform charging when charging the photoconductor drum 11 with electricity.

A structure including the spot-color removable member 711 as in the present exemplary embodiment is less likely to cause a trouble attributable to deformation of the charging member 12.

As illustrated in FIG. 2, the spot-color removable member 711 further includes two protrusions 94 on the side opposite to the side where the spacing protrusions 711C (refer to FIG. 3) are disposed.

In the present exemplary embodiment, the two protrusions 94 include a first-end protrusion 94A and a second-end protrusion 94B.

In the present exemplary embodiment, as described below, when a user performs an operation of attaching the spot-color attachable body 81 to which the spot-color removable member 711 is attached to the apparatus body 100A, the first-end protrusion 94A comes into contact with the apparatus body 100A of the image forming apparatus 100.

Thus, in the present exemplary embodiment, the spot-color attachable body 81 to which the spot-color removable member 711 is attached is prevented from being attached to the image forming apparatus 100.

The first-end protrusion 94A and the second-end protrusion 94B are exposed and located at positions to be touchable by a user.

In the present exemplary embodiment, the direction indicated with arrow 2A in the drawing is a direction in which the spot-color removable member 711 is removed from the spot-color attachable body 81.

The first-end protrusion 94A and the second-end protrusion 94B protrude in the direction in which the spot-color removable member 711 is removed from the spot-color attachable body 81.

The spot-color attachable body 81 includes a first end portion 81C and a second end portion 81D located at different positions in the longitudinal direction.

In the present exemplary embodiment, when the spot-color attachable body 81 is to be attached to the image forming apparatus 100, the spot-color attachable body 81 is attached to the image forming apparatus 100 while using the first end portion 81C of the spot-color attachable body 81 in the longitudinal direction at a leading end.

In the present exemplary embodiment, the spot-color attachable body 81 is attached to the image forming apparatus 100 by inserting the spot-color attachable body 81 into the image forming apparatus 100. At this time, the spot-color attachable body 81 is inserted into the image forming apparatus 100 using the first end portion 81C of the spot-color attachable body 81 in the longitudinal direction at a leading end.

The first-end protrusion 94A is disposed at a position closer to the first end portion 81C of the spot-color attachable body 81 than to the second end portion 81D of the spot-color attachable body 81. The first end portion 81C is used as a leading end when the spot-color attachable body 81 is attached to the image forming apparatus 100.

The second-end protrusion 94B that protrudes from the spot-color removable member 711 in the same direction as the first-end protrusion 94A is disposed at a position closer to the second end portion 81D of the spot-color attachable body 81.

The second-end protrusion 94B also protrudes in the direction in which the spot-color removable member 711 is removed.

In the present exemplary embodiment, the direction in which the first-end protrusion 94A protrudes is parallel to the direction in which the second-end protrusion 94B protrudes.

The direction in which the spot-color attachable body 81 is attached to the image forming apparatus 100 is the direction indicated with arrow 2B. The direction in which the spot-color removable member 711 is removed is the direction indicated with arrow 2A.

In the present exemplary embodiment, the spot-color removable member 711 is removed from the spot-color attachable body 81 by being moved in a direction crossing an attachment direction in which the spot-color attachable body 81 is attached to the image forming apparatus 100.

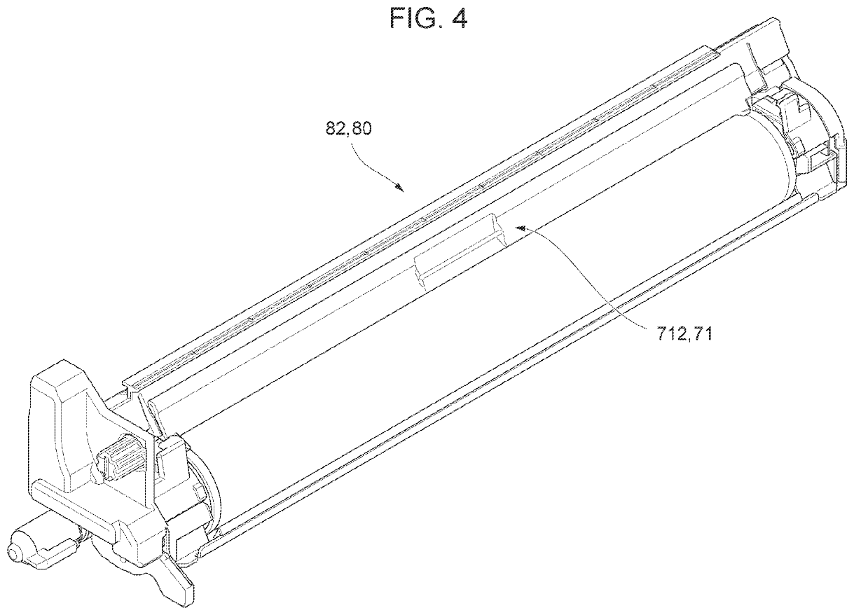

FIG. 4 is a perspective view of the process-color attachable body 82.

FIG. 4 illustrates the process-color attachable body 82 or the attachable body 80 for each process color to be attached to the corresponding one of the image forming portions 200 denoted with reference signs 91A to 91D in FIG. 1.

The process-color attachable body 82 has the same structure as the spot-color attachable body 81.

The process-color removable member 712 serving as the removable member 71 is attached to the process-color attachable body 82. The process-color attachable body 82 is an attachable body to which the process-color removable member 712 is attachable.

As illustrated in FIG. 2, the first-end protrusion 94A and the second-end protrusion 94B are disposed on the spot-color removable member 711. In contrast, the first-end protrusion 94A and the second-end protrusion 94B are not disposed on the process-color removable member 712.

The process-color attachable body 82 has the same structure as the spot-color attachable body 81 except for excluding the first-end protrusion 94A and the second-end protrusion 94B.

In the present exemplary embodiment, the first-end protrusion 94A and the second-end protrusion 94B are not disposed on the process-color removable member 712 to be attached to the process-color attachable body 82 (refer to FIG. 4) serving as an example of another attachable body.

In the present exemplary embodiment, the first-end protrusion 94A and the second-end protrusion 94B not disposed on the process-color removable member 712 are disposed on the spot-color removable member 711 (refer to FIG. 2).

As described below, the spot-color attachable body 81 illustrated in FIG. 2 is an attachable body that is prevented from being attached to the image forming apparatus 100 while the removable member 71 is attached to the attachable body.

The first-end protrusion 94A and the second-end protrusion 94B not disposed on the process-color removable member 712 are disposed on the spot-color removable member 711 attached to the spot-color attachable body 81.

In the present exemplary embodiment including the first-end protrusion 94A, the spot-color attachable body 81 is prevented from being attached to the image forming apparatus 100 while the removable member 71 is attached to the attachable body.

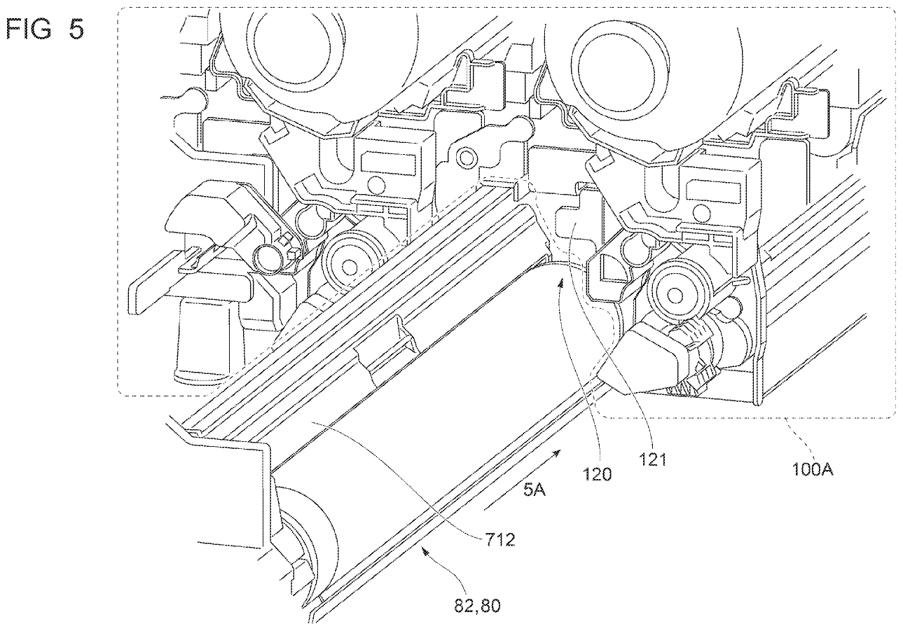

FIG. 5 is a diagram of the process-color attachable body 82 starting to be attached to the apparatus body 100A of the image forming apparatus 100.

In the present exemplary embodiment, the receiving portion 120 is provided for each process-color attachable body 82, and the process-color attachable body 82 to be attached to the apparatus body 100A is attached to the corresponding receiving portion 120.

Each of the receiving portions 120 has a hole extending in the depth direction of the image forming apparatus 100, and the process-color attachable body 82 is inserted into the hole to be attached to the receiving portion 120.

To be attached, the process-color attachable body 82 moves in the direction of arrow 5A.

In the present exemplary embodiment, as illustrated in FIG. 1, six receiving portions 120 are included. As illustrated in FIG. 5, each of the six receiving portions 120 includes a stop portion 121.

When the process-color attachable body 82 is to be attached, the process-color removable member 712 attached to the process-color attachable body 82 does not come into contact with the stop portion 121.

Thus, the process-color attachable body 82 is allowed to be attached to the receiving portion 120 also when the process-color removable member 712 is attached to the process-color attachable body 82.

The process-color attachable body 82 serving as an example of a first attachable body is thus allowed to be attached to the apparatus body 100A when the process-color removable member 712 is attached the process-color attachable body 82.

In the present exemplary embodiment, the process-color attachable body 82 does not come into contact with the stop portion 121 also when the process-color removable member 712 is removed from the process-color attachable body 82.

Thus, the process-color attachable body 82 is allowed to be attached to the receiving portion 120 also when the process-color removable member 712 is removed from the process-color attachable body 82.

The process-color attachable body 82 is allowed to be attached to the apparatus body 100A either in the case where the process-color removable member 712 is attached to the process-color attachable body 82 or in the case where the process-color removable member 712 is removed from the process-color attachable body 82.

Of the multiple attachable bodies 80, the process-color attachable body 82 or the attachable body 80 that forms toner images of any of cyan, magenta, yellow, and black process colors is allowed to be attached to the apparatus body 100A while the process-color removable member 712 is attached to the process-color attachable body 82.

The multiple attachable bodies 80 are provided for different colors, and used to form toner images of different colors.

The process-color attachable body 82 in the multiple attachable bodies 80 is allowed to be attached to the apparatus body 100A while the process-color removable member 712 is attached to the process-color attachable body 82.

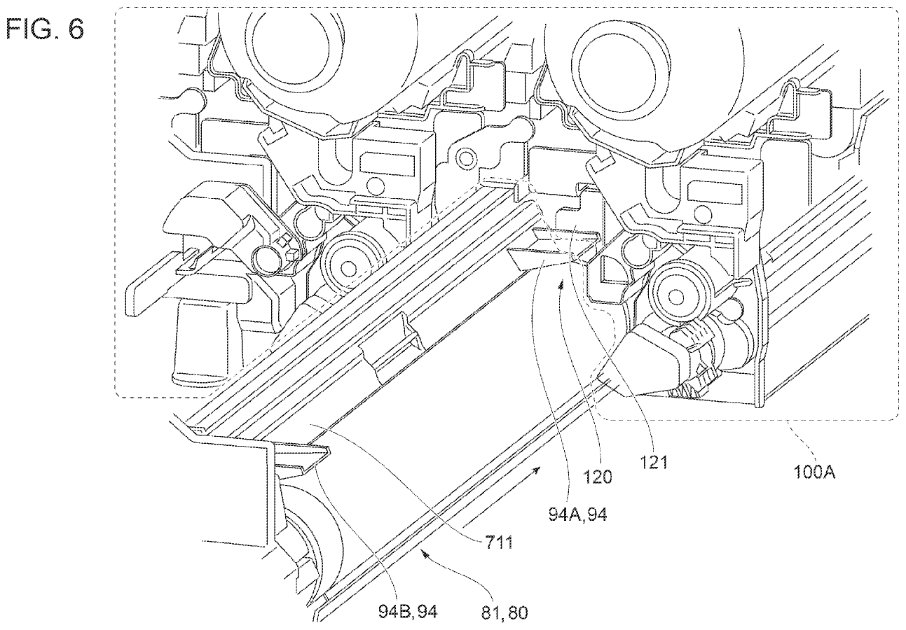

FIG. 6 is a diagram of the spot-color attachable body 81 that has started to be attached to the apparatus body 100A of the image forming apparatus 100.

When the spot-color attachable body 81 is to be attached to the corresponding receiving portion 120, the spot-color removable member 711 attached to the spot-color attachable body 81 comes into contact with the stop portion 121 disposed at the receiving portion 120. More specifically, the first-end protrusion 94A disposed at the spot-color removable member 711 comes into contact with the stop portion 121.

This structure restricts movement of the spot-color attachable body 81 to prevent attachment of the spot-color attachable body 81.

In the present exemplary embodiment, the spot-color attachable body 81 is prevented from being attached to the receiving portion 120 while the spot-color removable member 711 is attached to the spot-color attachable body 81.

As described above, the spot-color removable member 711 attached to the spot-color attachable body 81 serving as an example of a second attachable body includes a first-end protrusion 94A, not included in the process-color removable member 712.

In the present exemplary embodiment, the movement of the spot-color attachable body 81 is restricted as a result of the first-end protrusion 94A hitting against the stop portion 121 disposed at the apparatus body 100A.

Of the multiple attachable bodies 80, the spot-color attachable body 81 used to form spot-color images with the color other than the process colors is prevented from being attached to the apparatus body 100A while the spot-color removable member 711 is attached to the spot-color attachable body 81 as described above.

Of the multiple attachable bodies 80 attached to the apparatus body 100A, the process-color attachable body 82 serving as an example of a first attachable body is allowed to be attached to the corresponding receiving portion 120 while the process-color removable member 712 is attached to the process-color attachable body 82.

In contrast, the spot-color attachable body 81 serving as an example of a second attachable body is prevented from being attached to the corresponding receiving portion 120 while the spot-color removable member 711 is attached to the spot-color attachable body 81.

The process-color attachable body 82 is the attachable body 80 that forms toner images of any of four colors of cyan, magenta, yellow, and black.

In contrast, the spot-color attachable body 81 that is prevented from being attached to the image forming apparatus 100 while the removable member 71 is attached to the spot-color attachable body 81 is the attachable body 80 that forms toner images of a color other than these four colors.

In the present exemplary embodiment, the process-color removable members 712 attached to the process-color attachable bodies 82 have a different shape from the spot-color removable members 711 attached to the spot-color attachable bodies 81.

More specifically, as described above, each spot-color removable member 711 includes the first-end protrusion 94A and the second-end protrusion 94B serving as the two protrusions 94, and the spot-color removable member 711 thus has a shape including the protrusions 94.

In contrast, each process-color removable member 712 has a shape with no protrusions 94.

Thus, each process-color attachable body 82 is allowed to be attached to the apparatus body 100A, and each spot-color attachable body 81 is prevented from being attached to the apparatus body 100A.

The spot-color attachable body 81 is an attachable body that is to be attached to the image forming apparatus 100 and that forms one of the multiple attachable bodies 80 each including the removable member 71.

The spot-color attachable body 81 is the attachable body 80 that receives the removable member 71 with a shape different from the shape of the removable member 71 attached to the process-color attachable body 82.

The spot-color attachable body 81 is the attachable body 80 prevented from being attached to the image forming apparatus 100 when the spot-color attachable body 81 is to be attached to the image forming apparatus 100 while the spot-color removable member 711 is attached to the spot-color attachable body 81.

The spot-color attachable body 81 is the attachable body 80 that allows the spot-color removable member 711 to come into contact with the image forming apparatus 100 when the spot-color attachable body 81 is to be attached to the image forming apparatus 100 while the spot-color removable member 711 is attached to the spot-color attachable body 81.

Thus, in the present exemplary embodiment, the spot-color attachable body 81 is prevented from being attached to the image forming apparatus 100 while the spot-color removable member 711 is attached to the spot-color attachable body 81.

The spot-color attachable body 81 is allowed to be attached to the apparatus body 100A when the spot-color removable member 711 is removed from the spot-color attachable body 81.

When the spot-color removable member 711 is removed from the spot-color attachable body 81, the first-end protrusion 94A and the second-end protrusion 94B do not come into contact with the stop portion 121.

Thus, the spot-color attachable body 81 is allowed to be attached to the receiving portion 120 disposed at the apparatus body 100A.

The spot-color attachable body 81 may be prepared individually for each user in response to an individual order from the user. The spot-color attachable body 81 may be attached to the apparatus body 100A of the image forming apparatus 100 by a user inexperienced in the operation instead of an expert operator.

In this case, in a structure not including the first-end protrusion 94A, the image forming apparatus 100 to which the spot-color attachable body 81 is attached may operate while the spot-color removable member 711 remains attached to the spot-color attachable body 81. In this case, the image forming apparatus 100 or the attachable body 80 may cause a trouble.

In contrast, in a structure where the attachable body 80 is allowed to be attached to the image forming apparatus 100 while the removable member 71 is attached to the attachable body 80, for example, the image forming apparatus 100 is allowed for shipment while the attachable body 80 to which the removable member 71 is attached is installed in the image forming apparatus 100. In this case, a trouble such as a shipment of the attachable body 80 separate from the image forming apparatus 100 is avoidable.

Each process-color attachable body 82 is the attachable body 80 prepared as a default setting instead of separately prepared. As described above, the process-color attachable body 82 is allowed to be attached to the image forming apparatus 100 while the process-color removable member 712 is attached to the process-color attachable body 82.

In this case, to ship the image forming apparatus 100, the image forming apparatus 100 is allowed for shipment while the process-color attachable body 82 is attached to the image forming apparatus 100, and a trouble such as a shipment of the process-color attachable body 82 separate from the image forming apparatus 100 is avoidable.

The process-color removable member 712 attached to the process-color attachable body 82 attached to the shipped image forming apparatus 100 is removed from the process-color attachable body 82 by an expert operator after the image forming apparatus 100 is installed at the destination.

Thus, the process-color removable member 712 attached to the process-color attachable body 82 is less likely to fail to be removed. Thus, the image forming apparatus 100 to which the process-color attachable body 82 is attached is less likely to operate while the process-color removable member 712 remains attached to the process-color attachable body 82.

In the present exemplary embodiment, the process-color attachable body 82 is allowed to be attached while the process-color removable member 712 is attached to the process-color attachable body 82, and the spot-color attachable body 81 is prevented from being attached while the spot-color removable member 711 is attached to the spot-color attachable body 81.

In this case, the image forming apparatus 100 is less likely to operate while the attachable body 80 to which the removable member 71 remains attached is attached to the image forming apparatus 100.

In this case, a subset of the attachable bodies 80 is allowed to be attached to the image forming apparatus 100 at the shipment of the image forming apparatus 100. In this case, a trouble such as a shipment of the subset of the attachable bodies 80 separate from the image forming apparatus 100 is avoidable. Thus, the shipment operation is performed efficiently.

### (Others)

The receiving portion 120 to which the process-color attachable body 82 is attached may have a different shape from the receiving portion 120 to which the spot-color attachable body 81 is attached to allow the process-color attachable body 82 to be attached to the apparatus body 100A and to prevent the spot-color attachable body 81 from being attached to the apparatus body 100A.

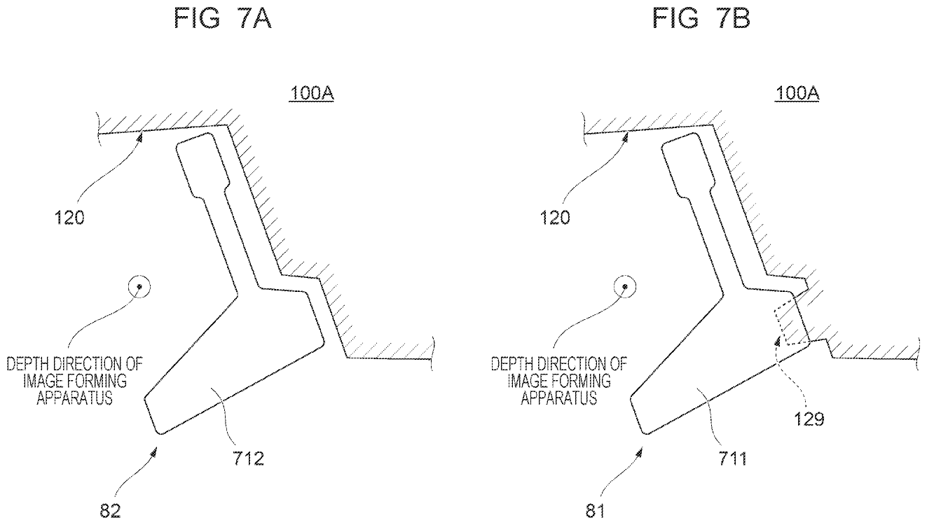

FIGS. 7A and 7B are diagrams of the receiving portion 120 having another structure.

FIG. 7A illustrates the receiving portion 120 to which the process-color attachable body 82 is attached, and FIG. 7B illustrates the receiving portion 120 to which the spot-color attachable body 81 is attached.

FIG. 7A illustrates the process-color removable member 712 and the receiving portion 120. FIG. 7B illustrates the spot-color removable member 711 and the receiving portion 120.

In FIG. 7A, the process-color removable member 712 moves in the direction perpendicular to the plane of FIGS. 7A and 7B and to the rear with respect to the plane. Also in FIG. 7B, the spot-color removable member 711 moves in the direction perpendicular to the plane of FIGS. 7A and 7B and to the rear with respect to the plane.

In the example structures illustrated in FIGS. 7A and 7B, the process-color removable member 712 has the same shape as the spot-color removable member 711.

In contrast, in the example structures illustrated in FIGS. 7A and 7B, the receiving portion 120 to which the process-color attachable body 82 is attached has a different shape from the receiving portion 120 to which the spot-color attachable body 81 is attached.

As illustrated in FIG. 7B, the receiving portion 120 to which the spot-color attachable body 81 is attached includes a protrusion 129 that protrudes to the path along which the spot-color removable member 711 moves.

In contrast, as illustrated in FIG. 7A, the receiving portion 120 to which the process-color attachable body 82 is attached includes no protrusion that protrudes to the path along which the process-color removable member 712 moves.

In these example structures, as illustrated in FIG. 7B, the receiving portion 120 to which the spot-color attachable body 81 is attached includes the protrusion 129 that is not included in the receiving portion 120 to which the process-color attachable body 82 (refer to FIG. 7A) is attached.

In this example structure, the spot-color removable member 711 attached to the spot-color attachable body 81 hits against the protrusion 129 included in the receiving portion 120. Thus, the spot-color attachable body 81 is prevented from being attached to the apparatus body 100A while the spot-color removable member 711 is attached to the spot-color attachable body 81.

In contrast, the receiving portion 120 to which the process-color attachable body 82 is attached includes no protrusion, and thus, the process-color attachable body 82 is allowed to be attached to the apparatus body 100A while the process-color removable member 712 is attached to the process-color attachable body 82.

In the above, the attachable body 80 including the photoconductor drum 11, the charging member 12, and the drum cleaner 17 is described as an example of an attachable body. However, the structure described above is applicable to attachment of an attachable body of another type to the image forming apparatus 100.

Examples of an attachable body of another type include a toner cartridge, and the development device 14. The structure described above is applicable to attachment of an attachable body of another type to the image forming apparatus 100.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An image forming apparatus comprising:
an apparatus body; and
a plurality of receiving portions that receive a plurality of attachable bodies to each of which a removable member is attachable,
wherein a first one of the plurality of attachable bodies attached to the apparatus body is allowed to be attached to a corresponding one of the receiving portions while the removable member is attached to the first attachable body, and a second one of the plurality of attachable bodies is prevented from being attached to a corresponding one of the receiving portions while the removable member is attached to the second attachable body.

(((2))) The image forming apparatus according to (((1))),
wherein the second attachable body is allowed to be attached to the corresponding receiving portion when the removable member is removed from the second attachable body.

(((3))) The image forming apparatus according to (((1))) or (((2))),
wherein the first attachable body is allowed to be attached to the corresponding receiving portion in either a state where the removable member is attached to the first attachable body or a state where the removable member is removed from the first attachable body.

(((4))) The image forming apparatus according to any one of (((1))) to (((3))),
wherein the removable member separates a first subset of a plurality of components included in each of the attachable bodies from a second subset of the plurality of components.

(((5))) The image forming apparatus according to (((4))),
wherein, when the removable member is removed from the attachable body, the first subset of the plurality of components moves toward the second subset of the plurality of components to come into contact with the second subset of the plurality of components.

(((6))) The image forming apparatus according to (((5))),
wherein the second subset of the plurality of components is an image carrier that carries an image to be formed, and the first subset of the plurality of components is a charging member that charges the image carrier with electricity, and
wherein, when the removable member is removed from the attachable body, the charging member moves toward the image carrier to come into contact with the image carrier.

(((7))) The image forming apparatus according to any one of (((1))) to (((6))),
wherein the plurality of attachable bodies are provided for respective colors, and form images of different colors, and
wherein an attachable body of the plurality of attachable bodies that forms images of any of four colors including cyan, magenta, yellow, and black is allowed to be attached to the corresponding receiving portion while the removable member is attached to the attachable body, and an attachable body of the plurality of attachable bodies that forms images of a color other than the four colors is prevented from being attached to the corresponding receiving portion while the removable member is attached to the attachable body.

(((8))) The image forming apparatus according to any one of (((1))) to (((7))),
wherein the removable member that is to be attached to the first attachable body has a shape different from a shape of the removable member that is to be attached to the second attachable body, to allow the first attachable body to be attached to the corresponding receiving portion, and to prevent the second attachable body from being attached to the corresponding receiving portion.

(((9))) The image forming apparatus according to (((8))),
wherein the removable member that is to be attached to the second attachable body includes a protrusion not included in the removable member that is to be attached to the first attachable body, and
wherein the protrusion hits against the receiving portion to prevent the second attachable body from being attached to the corresponding receiving portion while the removable member is attached to the second attachable body.

(((10))) The image forming apparatus according to any one of (((1))) to (((7))),
wherein the receiving portion to which the first attachable body is attached in the apparatus body has a different shape from a shape of the receiving portion to which the second attachable body is attached in the apparatus body to allow the first attachable body to be attached to the corresponding receiving portion, and to prevent the second attachable body from being attached to the corresponding receiving portion.

(((11))) The image forming apparatus according to (((10))),
wherein the receiving portion to which the second attachable body is attached includes a protrusion not included in the receiving portion to which the first attachable body is attached, and
the removable member attached to the second attachable body hits against the protrusion to prevent the second attachable body from being attached to the corresponding receiving portion while the removable member is attached to the second attachable body.

(((12))) An attachable body included in a plurality of attachable bodies attached to an image forming apparatus and each including a removable member,
wherein the removable member attached to the attachable body has a shape different from a shape of a removable member that is to be attached to a second attachable body that is included in the plurality of attachable bodies and that is allowed to be attached to the image forming apparatus while the removable member is attached to the second attachable body, and
wherein when the attachable body is to be attached to the image forming apparatus while the removable member is attached to the attachable body, the removable member comes into contact with the image forming apparatus to prevent the attachable body from being attached to the image forming apparatus.

(((13))) The attachable body according to (((12))),
wherein the removable member attached to the attachable body that is prevented from being attached to the image forming apparatus while the removable member is attached to the attachable body includes a protrusion not included in the removable member that is to be attached to the second attachable body, and
wherein the protrusion comes into contact with the image forming apparatus to prevent the attachable body from being attached to the image forming apparatus while the removable member is attached to the attachable body.

(((14))) The attachable body according to (((13))), wherein the protrusion is located at a position to be touchable by a user.

(((15))) The attachable body according to (((14))), wherein the protrusion protrudes in a removal direction in which the removable member is removed from the attachable body.

(((16))) The attachable body according to any one of (((13))) to (((15))),
wherein each of the plurality of attachable bodies includes a first end portion and a second end portion located at different positions in a longitudinal direction, and is attached to the image forming apparatus while inserting the first end portion in the longitudinal direction into the image forming apparatus as a leading end, and
wherein the protrusion is disposed at a position closer to the first end portion of the attachable body than to the second end portion of the attachable body.

(((17))) The attachable body according to (((16))),
wherein a second protrusion that protrudes from the removable member in a direction in which the protrusion protrudes is disposed at a position closer to the second end portion of the attachable body.

(((18))) The attachable body according to any one of (((12))) to (((17))),
wherein the removable member is allowed to be removed from the attachable body by being moved in a direction crossing an attachment direction in which the attachable body is attached to the image forming apparatus.

(((19))) The attachable body according to any one of (((12))) to (((18))),
wherein the second attachable body is an attachable body that forms images of any of four colors including cyan, magenta, yellow, and black, and
wherein the attachable body that is prevented from being attached to the image forming apparatus while the removable member is attached to the attachable body is an attachable body that forms images of a color other than the four colors.

What is claimed is:

1. An image forming apparatus comprising:
an apparatus body; and
a plurality of receiving portions that receive a plurality of attachable bodies to each of which a removable member is attachable,
wherein a first one of the plurality of attachable bodies attached to the apparatus body is allowed to be attached to a corresponding one of the receiving portions while the removable member is attached to the first attachable body, and a second one of the plurality of attachable bodies is prevented from being attached to a corresponding one of the receiving portions while the removable member is attached to the second attachable body.

2. The image forming apparatus according to claim 1,
wherein the second attachable body is allowed to be attached to the corresponding receiving portion when the removable member is removed from the second attachable body.

3. The image forming apparatus according to claim 1,
wherein the first attachable body is allowed to be attached to the corresponding receiving portion in either a state where the removable member is attached to the first attachable body or a state where the removable member is removed from the first attachable body.

4. The image forming apparatus according to claim 1,
wherein the removable member separates a first subset of a plurality of components included in each of the attachable bodies from a second subset of the plurality of components.

5. The image forming apparatus according to claim 4,
wherein, when the removable member is removed from the attachable body, the first subset of the plurality of components moves toward the second subset of the plurality of components to come into contact with the second subset of the plurality of components.

6. The image forming apparatus according to claim 5,
wherein the second subset of the plurality of components is an image carrier that carries an image to be formed, and the first subset of the plurality of components is a charging member that charges the image carrier with electricity, and
wherein, when the removable member is removed from the attachable body, the charging member moves toward the image carrier to come into contact with the image carrier.

7. The image forming apparatus according to claim 1,
wherein the plurality of attachable bodies are provided for respective colors, and form images of different colors, and
wherein an attachable body of the plurality of attachable bodies that forms images of any of four colors including cyan, magenta, yellow, and black is allowed to be attached to the corresponding receiving portion while the removable member is attached to the attachable body, and an attachable body of the plurality of attachable bodies that forms images of a color other than the four colors is prevented from being attached to the corresponding receiving portion while the removable member is attached to the attachable body.

8. The image forming apparatus according to claim 1,
wherein the removable member that is to be attached to the first attachable body has a shape different from a shape of the removable member that is to be attached to the second attachable body, to allow the first attachable body to be attached to the corresponding receiving portion, and to prevent the second attachable body from being attached to the corresponding receiving portion.

9. The image forming apparatus according to claim 8,
wherein the removable member that is to be attached to the second attachable body includes a protrusion not included in the removable member that is to be attached to the first attachable body, and
wherein the protrusion hits against the receiving portion to prevent the second attachable body from being attached to the corresponding receiving portion while the removable member is attached to the second attachable body.

10. The image forming apparatus according to claim 1,
wherein the receiving portion to which the first attachable body is attached in the apparatus body has a different shape from a shape of the receiving portion to which the second attachable body is attached in the apparatus body to allow the first attachable body to be attached to the corresponding receiving portion, and to prevent the second attachable body from being attached to the corresponding receiving portion.

11. The image forming apparatus according to claim 10,
wherein the receiving portion to which the second attachable body is attached includes a protrusion not included in the receiving portion to which the first attachable body is attached, and
the removable member attached to the second attachable body hits against the protrusion to prevent the second attachable body from being attached to the corresponding receiving portion while the removable member is attached to the second attachable body.

12. An attachable body included in a plurality of attachable bodies attached to an image forming apparatus and each including a removable member,
wherein the removable member attached to the attachable body has a shape different from a shape of a removable member that is to be attached to a second attachable body that is included in the plurality of attachable bodies and that is allowed to be attached to the image forming apparatus while the removable member is attached to the second attachable body, and
wherein when the attachable body is to be attached to the image forming apparatus while the removable member is attached to the attachable body, the removable member comes into contact with the image forming apparatus to prevent the attachable body from being attached to the image forming apparatus.

13. The attachable body according to claim 12,
wherein the removable member attached to the attachable body that is prevented from being attached to the image forming apparatus while the removable member is attached to the attachable body includes a protrusion not included in the removable member that is to be attached to the second attachable body, and
wherein the protrusion comes into contact with the image forming apparatus to prevent the attachable body from being attached to the image forming apparatus while the removable member is attached to the attachable body.

14. The attachable body according to claim 13, wherein the protrusion is located at a position to be touchable by a user.

15. The attachable body according to claim 14, wherein the protrusion protrudes in a removal direction in which the removable member is removed from the attachable body.

16. The attachable body according to claim 13,
wherein each of the plurality of attachable bodies includes a first end portion and a second end portion located at different positions in a longitudinal direction, and is attached to the image forming apparatus while inserting the first end portion in the longitudinal direction into the image forming apparatus as a leading end, and
wherein the protrusion is disposed at a position closer to the first end portion of the attachable body than to the second end portion of the attachable body.

17. The attachable body according to claim 16,
wherein a protrusion that protrudes from the removable member in a direction in which the protrusion protrudes is further disposed at a position closer to the second end portion of the attachable body.

18. The attachable body according to claim 12,
wherein the removable member is allowed to be removed from the attachable body by being moved in a direction crossing an attachment direction in which the attachable body is attached to the image forming apparatus.

19. The attachable body according to claim 12,
wherein the second attachable body is an attachable body that forms images of any of four colors including cyan, magenta, yellow, and black, and
wherein the attachable body that is prevented from being attached to the image forming apparatus while the removable member is attached to the attachable body is an attachable body that forms images of a color other than the four colors.
